(19) United States
(12) Patent Application Publication
(10) Pub. No.: US 2005/0041356 A1
(43) Pub. Date: Feb. 24, 2005

(54) Circuit arrangement for protection against impulse voltages

(75) Inventors: Arwed Storm, Dachau (DE); Horst Werni, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 10/913,425

(22) Filed: Aug. 9, 2004

(30) Foreign Application Priority Data
Aug. 20, 2003 (DE) 103 38 921.0

(51) Int. Cl. H02H 3/22

(52) U.S. Cl. 361/118

(57) ABSTRACT

A circuit for protection against impulse voltages includes an input with first and second input connections to which is coupled a voltage that is loaded with an impulse voltage and corresponds to the system voltage, an output with first and second output connections to which the unit to be protected is coupled, and a protective circuit coupled between the first and second input or output connections. The protective circuit has a limiting apparatus that limits the voltage to a prescribable value, and a switch that includes a switching element and a drive circuit, the switching element being a semi-conductor component. The switch is arranged in series with the limiting apparatus and switches on responsive to a first trigger criterion and off responsive to a second trigger criterion.

### FIELD OF THE INVENTION

The present invention relates to a circuit arrangement for protection against impulse voltages of at least one unit to be supplied from a voltage network, having an input with a first and a second input connection to which it is possible to couple a voltage that is loaded with an impulse voltage and corresponds to the system voltage or has been derived from the system voltage, an output with a first and a second output connection to which the unit to be protected can be coupled, and a protective circuit that is coupled between the first and second input or output connection, the protective circuit having a limiting apparatus that is designed to limit the voltage present across it to a prescribable value.

### BACKGROUND OF THE INVENTION

The present invention is based in general on the problem of protecting equipment against impulse voltages such as are produced, for example, when motors are being switched on by lightning stroke or the like on a voltage network. Such impulse voltages, which are also known as surge impulses, can be up to 3000 V, and therefore constitute a potential risk to sensitive electronic equipment or electronic equipment with a sensitive input stage, for example electronic ballast for lighting engineering. Details on this topic can also be gathered from EN61547, paragraph 5.7.

It is known with electronic ballast to use boost converters that require no additional protective measures for protection against impulse voltages up to approximately 1500 V. Furthermore, varistors are used in the practice of protection. A varistor does not offer a satisfactory solution, however, since, as will be set forth in greater detail with reference to FIG. 2, its characteristic is “too soft”, and substantial losses can therefore arise as early as during operation, but at the latest in the case of unequal network loading.

Furthermore, it is known from the field of telephony to make use for protection against impulse voltages of sidacs whose current-voltage characteristic is the same in principle as that in FIG. 3 and will likewise be examined in more detail below. In the field of telephony, this solution offers adequate protection since the impedance of the input voltage source is large enough to provide sufficient limitation of the short-circuit current when a sidac is in the switched-on state, that is to say in the conducting state. Because of the excessively low impedance, no practical solution is offered by this for many other applications that are fed from the customary voltage network and not from the telephone network: were a sidac to be used there for protection, the excessively low impedance would activate the customary fuse, and this would then need to be reset by hand or replaced by another fuse.

### SUMMARY OF THE INVENTION

It is therefore the object of the present invention to develop the circuit arrangement named at the beginning so as to achieve reliable protection against impulse voltages, without the need for manual intervention after the occurrence of an impulse voltage in order to supply voltage once more to the unit that is to be supplied.

The invention is based on the finding that the above object can be achieved by virtue of the fact that the protective circuit comprises a switch apparatus in addition to the limiting apparatus. In this case, the switch apparatus comprises a switching element and a drive circuit for the switching element, the switching element being designed as a semiconductor component in order to ensure sufficiently precise dimensioning. A switching element, implemented as a semiconductor component, also offers the advantage that the sensitivities with regard to a voltage amplitude and/or a temporal change in a voltage can be adjusted independently of one another and precisely within a prescribable tolerance.

The switch apparatus and the limiting apparatus are now arranged in series and designed such that the switch apparatus is switched on given a prescribable first trigger criterion and switched off given the prescribable second trigger criterion.

Owing to the serial arrangement of the switch and limiting apparatuses, no current flows through the protective circuit as long as the switch does not respond, that is to say is not switched on or switched off. Consequently, as in the prior art it is possible to use a varistor as limiting apparatus; however—and this is contrary to the prior art—a varistor does not generate any kind of losses in normal operation, since no current flows through the protective apparatus as a consequence of the switch apparatus being switched off. In a serial arrangement with the limiting apparatus, it is now possible, for example, to use as switch apparatus a sidac which now—in contrast to the prior art—no longer produces a short circuit, since the impedance of the limiting apparatus prevents short circuiting. Resetting, that is to say switching off the protective apparatus, takes place automatically since whenever the impulse voltage decreases, for example whenever the current flowing through the protective apparatus drops below a prescribable limiting value, the result is that the switching element switches off again. The above findings have been represented using the example of implementing the limiting apparatus as a varistor and implementing the switch apparatus as a sidac. However, the present invention encompasses a multiplicity of further options of implementation, and these will be examined more precisely below.

Thus, a preferred embodiment is distinguished in that the first trigger criterion is the rise of a voltage, in particular the voltage present across the switch apparatus (10), above a first prescribable voltage value, and/or the rate of rise of a voltage, in particular the voltage present across the switch apparatus (10), above a first prescribable value. The latter offers the possibility to cause the protective circuit to respond as early as the detection of a suspicious edge, that is to say before damaging high voltage values are reached.

The second trigger criterion can be the drop in the current flowing through the switch apparatus (10) below a second prescribable current value, and/or the drop rate of a voltage, in particular the voltage present across the switch apparatus (10) is below a second prescribable value and/or a prescribable time period has elapsed.

The drive circuit can on the one hand be designed to drive the switching element in accordance with the electrical variables acting on the switch apparatus, in particular voltage, current, rate of voltage variation, rate of current variation.

Alternatively, the drive circuit can be formed by the switching element itself. This has the advantage that the drive circuit can be eliminated.

The limiting apparatus is preferably implemented as the already mentioned varistor and/or an ohmic resistor and/or a Zener diode. The switching element is preferably implemented as a triac and/or as a diac and/or as a sidac and/or as a TSPD (Thyristor Surge Protection Device) and/or as a thyristor and/or as an IGBT (Insolated Gate Bipolar Transistor) and/or as a suppressor diode and/or as a Transil diode. A gas arrester is not suitable, since owing to its function it cannot be dimensioned accurately enough with regard to its criterion for switching on and off. Inadequate protection would be the consequence.

The limiting apparatus is preferably designed for permanent operation on a voltage value that is below the maximum voltage without impulse voltage that is present at the protective apparatus during operation. Since the limiting apparatus is loaded only briefly in the present case, in particular at the time at which the switching element switches on or is switched on, whereas in permanent operation it is virtually unloaded, the result is this advantageous, cost-reducing method of underdimensioning. It is preferred to use a circuit arrangement according to the invention in an electrical converter, in particular in an electrical ballast for lighting engineering.

Further advantageous embodiments follow from the subclaims.

### BRIEF DESCRIPTION OF THE DRAWINGS

Exemplary embodiments of the present invention are described in more detail below with reference to the attached drawings, in which:

FIG. 1 shows a schematic of a circuit arrangement according to the invention;

FIG. 2 shows a schematic of the current-voltage characteristic of a limiting apparatus that can be used in a circuit arrangement according to the invention;

FIG. 3 shows a schematic of the current-voltage characteristic of a switching element that can be used in a circuit arrangement according to the invention;

FIG. 4 shows a first exemplary embodiment of a circuit arrangement according to the invention;

FIG. 5 shows a second exemplary embodiment of a circuit arrangement according to the invention;

FIG. 6a shows the time profile of a system voltage that is present at a circuit arrangement according to the invention and to which an impulse voltage is applied;

FIG. 6b shows a comparison of the time profile of the output voltage Uₒᵤₜ of a circuit arrangement according to the invention in the case of driving with the aid of the system voltage in accordance with FIG. 6a, for a circuit arrangement according to the invention and three circuit arrangements known from the prior art; and

FIG. 7 shows the measured time profile of the current through the protective circuit, the output voltage of the protective circuit and the voltage across the limiting apparatus for an implemented exemplary embodiment.

### DETAILED DESCRIPTION OF THE INVENTION

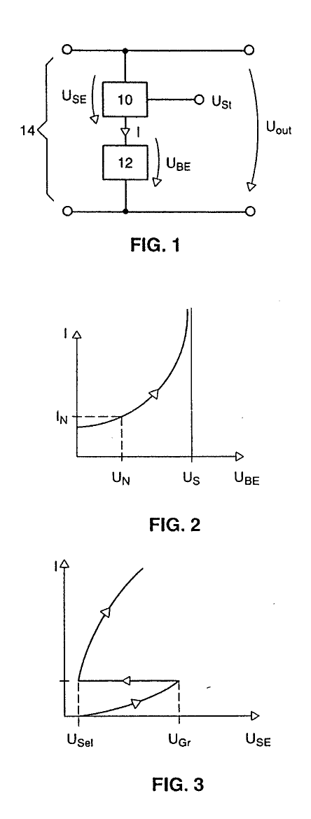

FIG. 1 shows by way of example the schematic of the design of a circuit arrangement according to the invention. This circuit arrangement comprises a serial arrangement of a switch apparatus 10 and a limiting apparatus 12 that form the protective circuit 14 together with a drive circuit (not illustrated). The voltage U_{SE} drops at the switch apparatus 10, while the voltage U_{BE} drops at the limiting apparatus 12. The current through the protective circuit 14 is denoted by I. Dropping at the protective circuit 14 of the circuit arrangement according to the invention is the output voltage U_{OUT}, which serves as input voltage for the downstream unit, which is to be protected. Furthermore, the voltage Uₛₜ serves to drive the switch apparatus 10.

FIG. 2 shows the dependence of the current on the voltage at a limiting apparatus 12, for example a varistor, which is to be used in the circuit arrangement according to the invention. Uₛ denotes the protective voltage, the aim being for the circuit arrangement according to the invention to prevent the protective voltage from being exceeded. When, as in the prior art, such a limiting apparatus 12 is used without a switch apparatus 10 arranged in series therewith, a sizeable current I_{N} already flows during normal operation given the voltage U_{N}. The product of the voltage U_{N} and the current I_{N} corresponds to the losses in such a limiting apparatus, and these are not desired. Since, however, no current flows through the protective circuit 14 in the case of the present invention as long as the switch apparatus 10 is switched off, there is no loss through the limiting apparatus 12 during normal operation of the circuit arrangement according to the invention.

FIG. 3 shows a typical profile of a current-voltage characteristic at a switch apparatus 10, in particular a switching element, in which the drive function is implemented by the switching element itself, for example a sidac. The arrows characterize the profile for a rising voltage. If the voltage U_{SE} exceeds a threshold value U_{Gr}, the switching element switches through, that is to say it switches on and the voltage U_{SE} decreases to a value U_{Sel}. The current then increases and the voltage U_{SE} begins to grow again as a consequence of the internal resistances of the switching element. As is evident to the person skilled in the art, the function that the switch apparatus 10 is required to have for the invention can also be achieved by means of a switching element, for example a transistor, that is appropriately driven. The associated drive circuit then evaluates either the magnitude or the rate of rise of the system voltage, or of a variable correlated therewith, in order to switch on the switching element, and evaluates the current flowing through the switching element, or the rate of variation of this current, or the corresponding parameters of a variable correlated therewith, in order once again to switch off the switching element. Switching elements which, however, already react directly to the electrical variables present at them, for example triac, diac, sidac, have the advantage that the drive circuit can be eliminated since it is implemented by the switching element itself. If the holding current in the case of the switching element in

FIG. 3 falls below a specific value, the switching element automatically switches itself off again.

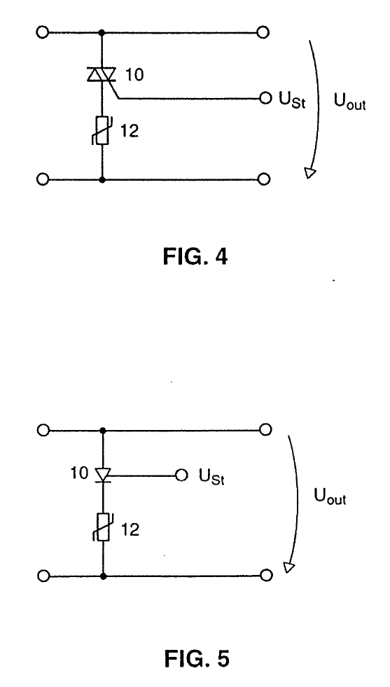

FIG. 4 shows a first exemplary embodiment of a circuit arrangement according to the invention, in which the limiting apparatus 12 is implemented as a varistor and the switch apparatus 10 is implemented as a triac with a controlling voltage Uₛₜ.

In the exemplary embodiment illustrated in FIG. 5, the limiting apparatus 12 is implemented, in turn, as a varistor, while the switch apparatus is implemented into a thyristor with a drive circuit (not illustrated).

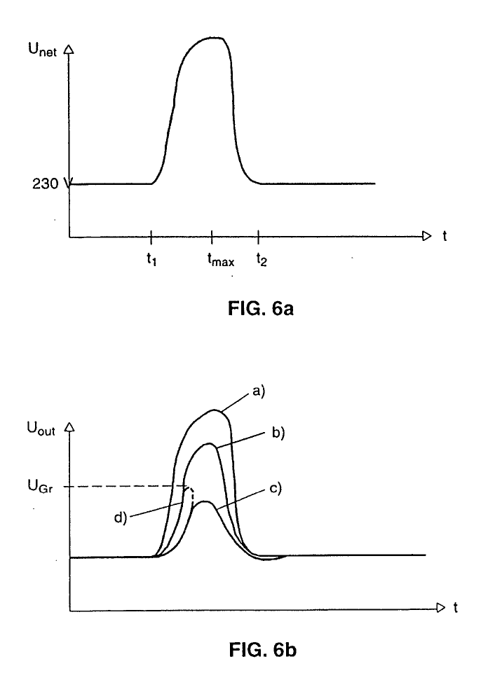

FIG. 6a now shows the time profile of the system voltage (assumed as 230 V by way of example), which is dominated during the time period t₁ to t₂ by an impulse voltage whose maximum is reached at the instant tₘₐₓ.

FIG. 6b shows schematically in this context four time profiles of the output voltage Uₒᵤₜ of three measures known from the prior art, and of the circuit arrangement according to the invention. The curve segment a) shows the profile of the output voltage Uₒᵤₜ when no kind of protective measures are taken. The curve segment b) shows the profile of Uₒᵤₜ when use is made only of one varistor that is dimensioned to 800 V. Although this does result in the advantage that the power loss converted in the varistor is very small in normal operation, it is truly to be seen that this solution does not provide sufficient protection. The curve segment c) shows the profile of the output voltage Uₒᵤₜ in the case of the use of only one varistor that is dimensioned to 400 V. Although this varistor does offer. suitable protection, it does disturb performance in normal operation owing to a high power loss conversion. The curve segment d) shows the profile of the output voltage for a circuit arrangement according to the invention: use is made of a sidac as switch apparatus 10, and of a varistor dimensioned to 400 V as limiting apparatus 12. It is clearly to be seen that the voltage firstly rises to the value U_{Gr} before the switch apparatus 10 is switched on, and then the amplitude is dominated by the voltage dropping at the limiting apparatus 12. Consequently, the curve segments c) and d) coincide in the second and third thirds of the profile. However, in the case of a circuit arrangement according to the invention a varistor dimensioned to 400 V does not disturb the normal operation of the subsequent circuit, since no current flows through it because of the fact that the switch apparatus 10 is switched off in the normal state.

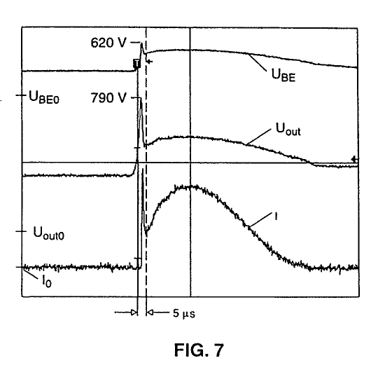

FIG. 7 shows the time profile of the current I through the protective apparatus 14, the output voltage Uₒᵤₜ of the protective apparatus, and the voltage U_{BE} across the limiting network 12 in the case of low-resistance coupling of an impulse voltage of 1000 V at the network voltage maximum (in accordance with paragraph 5.7 of EN 61547). FIG. 7 therefore confirms the tendencies sketched above with reference to FIG. 6. In order to provide a time reference, a time window of 5 ps is depicted about the impulse voltage in FIG. 7. The respective reference lines U_{outO}, U_{BE0} and I₀ are depicted in FIG. 7 in relation to the profiles of the current I, the output voltage Uₒᵤₜ and the voltage U_{BE}. In addition, the peak value 620 V is depicted for U_{BE}, and the peak value 790 V is depicted for Uₒᵤₜ₀.

The circuit arrangement according to the invention can be used to fulfill its function at the input of the circuit to be protected, upstream of a system rectifier, downstream of a system rectifier, across the module to be protected or across the component to be protected or at another location suitable in terms of circuitry. Given a suitable arrangement and dimensioning, the circuit arrangement according to the invention can ensure protection even in the case of surge impulses of more than 3000 V.

1. A circuit arrangement for protection against impulse voltages of at least one unit to be supplied from a voltage network, having
an input with a first and a second input connection to which it is possible to couple a voltage that is loaded with an impulse voltage and corresponds to the system voltage or has been derived from the system voltage,
an output with a first and a second output connection to which the unit to be protected can be coupled, and
a protective circuit that is coupled between the first and second input or output connection, the protective circuit having a limiting apparatus that is designed to limit the voltage present across it to a prescribable value,
wherein the protective circuit further comprises a switch apparatus (10) that comprises a switching element (10) and a drive circuit for the switching element (10), the switching element (10) being designed as a semi-conductor component, and the switch apparatus (10) being arranged in series with the limiting apparatus (12) and being designed to switch on given a prescribable first trigger criterion, and to switch off given a prescribable second trigger criterion.

2. The circuit arrangement as claimed in claim 1, wherein the first trigger criterion is the rise of a voltage, in particular the voltage present across the switch apparatus (10), above a first prescribable voltage value, and/or the rate of rise of a voltage, in particular the voltage present across the switch apparatus (10), above a first prescribable value.

3. The circuit arrangement as claimed in claim 1, wherein the second trigger criterion is the drop in the current flowing through the switch apparatus (10) below a second prescribable current value, and/or the drop rate of a voltage, in particular the voltage present across the switch apparatus (10) is below a second prescribable value and/or a prescribable time period has elapsed.

4. The circuit arrangement as claimed in claim 1, wherein the drive circuit is designed for driving the switching element (10) in accordance with at least one electrical variable acting across the switch apparatus (10) or a variable correlated therewith, in particular voltage, current, rate of voltage variation, rate of current variation.

5. The circuit arrangement as claimed in claim 1, wherein the drive circuit is formed by the switching element (10) itself.

6. The circuit arrangement as claimed in claim 1, wherein the limiting apparatus (12) comprises a varistor and/or a resistor and/or a Zener diode.

7. The circuit arrangement as claimed in claim 1, wherein the switching element (10) comprises a triac and/or a diac and/or a sidac and/or a TSPD and/or a thyristor and/or an IGBT and/or a suppressor diode and/or a Transil diode.

8. The circuit arrangement as claimed in claim 1, wherein the limiting apparatus (12) is designed for permanent operation on a voltage value that is below the maximum voltage without impulse voltage that is present at the protective apparatus during operation.

9. (cancelled)
